(19) United States
(12) Patent Application Publication
(10) Pub. No.: US 2020/0174488 A1
(43) Pub. Date: Jun. 4, 2020

(54) FALSE TARGET REMOVAL DEVICE AND METHOD FOR VEHICLES AND VEHICLE INCLUDING THE DEVICE

(71) Applicants: HYUNDAI MOTOR COMPNAY, Seoul (KR); KIA MOTORS CORPORATION, Seoul (KR)

(72) Inventor: Min Kyun YOO, Seoul (KR)

(21) Appl. No.: 16/525,995

(22) Filed: Jul. 30, 2019

(30) Foreign Application Priority Data
Dec. 4, 2018 (KR) 10-2018-0154448

(51) Int. Cl. G05D 1/02; B60W 50/02

(52) U.S. Cl. CPC G05D 1/0221; B60W 2050/0215; G05D 2201/0213; B60W 50/0205

(57) ABSTRACT

A false target removal device and method for vehicles that can determine whether a sensor fusion target is a false target and remove the false target and a vehicle including the device are disclosed. The false target removal device may include a learning unit for receiving sensor fusion measurement information and learning one or more parameters based on the received sensor fusion measurement information, a falseness determination unit for, upon receiving current sensor fusion measurement information, determining whether the current sensor fusion measurement information is false based on the one or more parameters learned by the learning unit, and a sensor fusion target generation unit for removing false target information and generating a sensor fusion target based on the result of the determination by the falseness determination unit.

This application claims the benefit of Korean Patent Application No. 10-2018-0154448, filed on Dec. 4, 2018, which is hereby incorporated by reference as if fully set forth herein.

### BACKGROUND

### Field

The present disclosure relates to a false target removal device for vehicles, and more particularly to a false target removal device and method for vehicles that are capable of determining whether a sensor fusion target is a false target and removing the false target and a vehicle including the device.

### Discussion of the Related Art

In general, a vehicle is equipped with various systems for protecting a driver and passengers, assisting the driver, and improving ride comfort. These systems have been improved and developed through utilization of various sensors and information communication technology.

Among them, technology for recognizing a lane and performing automatic steering using a camera-based image sensor has been put to practical use.

An image recognition and processing device provided in a vehicle may detect image information about a lane of a road on which the vehicle travels, image information about a rear vehicle, and image information about lanes to the left and right, and may display the detected image information through a display means in order to enable a driver to conveniently recognize the lanes and to inform the driver of the situation of the road on which the vehicle travels and information about travel of adjacent vehicles.

### SUMMARY

Accordingly, the present disclosure is directed to a false target removal device for vehicles, a false target removal method for vehicles, and a vehicle including the false target removal device that substantially obviate one or more problems due to limitations and disadvantages of the related art.

Aspects of the present disclosure provide a false target removal device and method for vehicles capable of determining whether the current sensor fusion measurement information is false based on parameters learned by a learning unit and removing false target information, whereby it is possible to efficiently prevent the generation of a false sensor fusion target and thus to improve the reliability of the sensor fusion and a vehicle including the false target removal device. As described herein, in some embodiments, “learning” particular information may include determining, calculating, generating, extracting, updating, or improving one or more parameters or models based on the particular information (or a portion thereof). Alternatively or additionally, in some embodiments, “learning” particular information may include determining, calculating, generating, extracting, updating, or improving the particular information (or a portion thereof).

Aspects of the present disclosure devised to solve the problems and the advantages thereof are not limited to those described herein, and other aspects and advantages will be clearly understood by those skilled in the art based on the following detailed description of the present disclosure.

As embodied and described herein, in an aspect of the present disclosure, a false target removal device for vehicles includes a learning unit for receiving and learning sensor fusion measurement information, a falseness determination unit for, upon receiving current sensor fusion measurement information, determining whether the current sensor fusion measurement information is false based on parameters learned by the learning unit, and a sensor fusion target generation unit for removing false target information and generating a sensor fusion target based on the result of the determination by the falseness determination unit.

In another aspect of the present invention, a false target removal method for vehicles includes receiving sensor fusion measurement information, learning the received sensor fusion measurement information, determining whether current sensor fusion measurement information is false based on the learned parameters, and removing false target information and generating a sensor fusion target upon determining that the current sensor fusion measurement information is false.

In another aspect of the present invention, a computer-readable recording medium containing a program for performing the false target removal method executes processes included in the false target removal method.

In a further aspect of the present invention, a vehicle includes a sensor fusion device for sensing a target and a false target removal device connected to the sensor fusion device through communication for removing false target information corresponding to the target, wherein the false target removal device includes a learning unit for receiving and learning sensor fusion measurement information, a falseness determination unit for, upon receiving current sensor fusion measurement information, determining whether the current sensor fusion measurement information is false based on parameters learned by the learning unit, and a sensor fusion target generation unit for removing false target information and generating a sensor fusion target based on the result of the determination by the falseness determination unit.

It is to be understood that both the foregoing general description and the following detailed description of the present disclosure are examples and are intended to provide further explanation of the embodiments of the present disclosure.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the techniques described in the present disclosure. In the drawings:

FIG. 1 is a block diagram illustrating a false target removal device for vehicles according to an embodiment of the present disclosure;

FIG. 2 is a view illustrating a false target removal process in FIG. 1;

FIG. 3 is a view illustrating a learning process in FIG. 2;

FIG. 4 is a view illustrating a falseness determination process in FIG. 2; and

FIG. 5 is a flowchart illustrating a false target removal method according to an embodiment of the present disclosure.

### DETAILED DESCRIPTION

Reference will now be made in detail to the various embodiments of the present disclosure, some examples of which are illustrated in the accompanying drawings. The following embodiments are given by way of example in order to enable those skilled in the art to fully understand the ideas and techniques described in the present disclosure. Therefore, the present disclosure is not limited by the following embodiments, and may be realized in various other forms. In order to clearly describe the present disclosure, parts having no relation with the description of the present disclosure have been omitted from the drawings. Wherever possible, the same reference numerals will be used throughout the specification to refer to the same or like parts.

The term “comprises” or “includes” used herein should be interpreted not to exclude other elements but to further include such other elements, unless mentioned otherwise. In addition, the term “unit” or “module” used herein signifies one unit that processes at least one function or operation, and may be realized by hardware, software, or a combination thereof. For example, one or more functions or operations described as being performed by a unit or module can be implemented as computer-executable instructions stored on non-transitory physical computer storage, where the computer-executable instructions, when executed by one or more hardware processors, cause the one or more hardware processors to perform the described functions or operations.

In recent years, a sensor fusion system capable of fusing image information and radar information collected through an image sensor and radar, respectively, in order to extract and use necessary information has been developed.

Such a sensor fusion system is used to provide an autonomous traveling system that recognizes lane information and controls automatic steering of a vehicle using a camera or a smart cruise control function of the vehicle.

However, the sensor fusion system may determine an object that is actually stationary to be a moving object and may generate a sensor fusion target due to a velocity determination error of the radar.

A false sensor fusion target may be generated on a guardrail or at the boundary of a road due to the velocity determination error of the radar.

For example, when the velocity determination error of the radar occurs, the sensor fusion system may recognize an object that is actually stationary as a moving object, and may generate a sensor fusion target.

The sensor fusion target generated as described above is a false target, which may cause a problem in controlling or recognizing a vehicle.

Therefore, there is a need to develop a false target removal device for vehicles that is capable of determining whether a sensor fusion target is a false target and efficiently removing the false target.

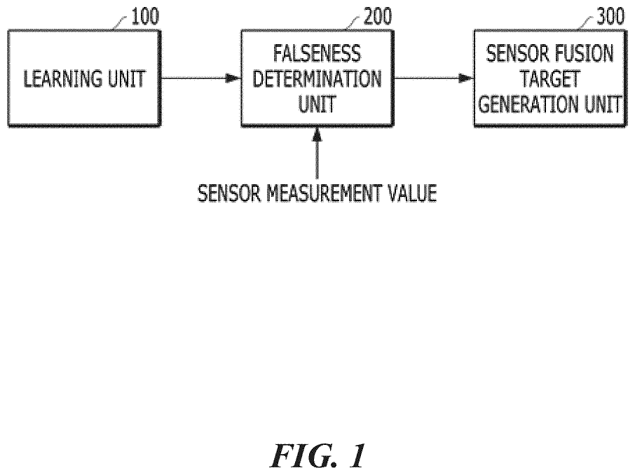

Hereinafter, a false target removal device and method for vehicles and a vehicle including the device, which may be applied to embodiments of the present disclosure, will be described in detail with reference to FIGS. 1 to 5.

FIG. 1 is a block diagram illustrating a false target removal device for vehicles according to an embodiment of the present disclosure.

As shown in FIG. 1, the false target removal device may include a learning unit 100 for receiving and learning sensor fusion measurement information, a falseness determination unit 200 for, upon receiving current sensor fusion measurement information, determining whether the current sensor fusion measurement information is false based on parameters learned by the learning unit 100, and a sensor fusion target generation unit 300 for removing false target information and generating a sensor fusion target based on the result of the determination by the falseness determination unit 200.

Here, the learning unit 100 may receive the sensor fusion measurement information from the radar of a host vehicle.

When learning the sensor fusion measurement information, the learning unit 100 may learn at least one of lateral relative velocity information, longitudinal relative velocity information, lateral position information, longitudinal position information, absolute velocity information, longitudinal relative acceleration information, heading angle information, or reception power intensity information.

For example, the sensor fusion measurement information may include velocity information of the host vehicle, and the absolute velocity information may be a value calculated based on the velocity information of the host vehicle.

For example, the sensor fusion measurement information may include lateral relative velocity information and longitudinal relative velocity information received from the radar, and the heading angle information may be a value calculated based on the lateral relative velocity information and the longitudinal relative velocity information received from the radar.

Depending on the circumstances, when learning the sensor fusion measurement information, the learning unit 100 may further learn false flag information.

When learning the sensor fusion measurement information, the learning unit 100 may perform learning based on a deep neural network (DNN) learning method.

When learning the sensor fusion measurement information, the learning unit 100 may extract a sensor value of the radar and a feature point of the host vehicle from the received sensor fusion measurement information, and may learn the extracted feature point.

When extracting the feature point, the learning unit 100 may extract at least one of lateral relative velocity, longitudinal relative velocity, lateral position, longitudinal position, absolute velocity, longitudinal relative acceleration, heading angle, or reception power intensity.

When learning the extracted feature point, the learning unit 100 may learn at least one of the lateral relative velocity, the longitudinal relative velocity, the lateral position, the longitudinal position, the absolute velocity, the longitudinal relative acceleration, the heading angle, or the reception power intensity.

Depending on the circumstances, when learning the extracted feature point, the learning unit 100 may further learn false flag information.

When learning the extracted feature point, the learning unit 100 may perform learning based on the deep neural network (DNN) learning method.

The falseness determination unit 200 may extract a sensor value of the radar and a feature point of the host vehicle upon receiving the current sensor fusion measurement information, may determine whether an input value of the feature point is false based on the learned parameters corresponding to the extracted feature point, may calculate a false flag value corresponding to the input value of the feature point based on the result of the determination, and may sort (or classify, categorize, or group) the input value of the feature point based on the calculated false flag value.

When extracting the feature point, the falseness determination unit 200 may extract at least one of lateral relative velocity, longitudinal relative velocity, lateral position, longitudinal position, absolute velocity, longitudinal relative acceleration, heading angle, or reception power intensity.

When determining whether the input value of the feature point is false, the falseness determination unit 200 may determine whether the input value of the feature point is false based on a predetermined determination reference value. For example, the falseness determination unit 200 may compare the input value of the feature point (or the probability that the input value is false) to a predetermined determination reference value.

For example, the determination reference value may be a falseness probability value of 0.5. However, the present disclosure is not limited thereto, and other falseness probability values may be used.

When calculating the false flag value, the falseness determination unit 200 may calculate the false flag value to be 1 upon determining that the input value of the feature point is false, and may calculate the false flag value to be 0 upon determining that the input value of the feature point is not false. However, the present disclosure is not limited thereto, and other false flag values may be used.

When generating the sensor fusion target, the sensor fusion target generation unit 300 may check a false flag value corresponding to the sensor fusion measurement information received from the falseness determination unit 200, may recognize the sensor fusion measurement information as false target information based on determining that the false flag value is false, may remove the recognized false target information, and may generate the sensor fusion target.

When checking the false flag value corresponding to the sensor fusion measurement information, the sensor fusion target generation unit 300 may check a false flag value corresponding to the sensor value of the radar and the input value of the feature point of the host vehicle.

For example, when checking the false flag value corresponding to the sensor fusion measurement information, the sensor fusion target generation unit 300 may recognize the sensor fusion measurement information as false target information based on determining that the false flag value is 1, and may recognize the sensor fusion measurement information as real target information based on determining that the false flag value is 0.

When checking the false flag value corresponding to the sensor fusion measurement information received from the falseness determination unit 200, the sensor fusion target generation unit 300 may recognize the sensor fusion measurement information as real target information based on determining that the false flag value is not false, and may generate the sensor fusion target (e.g., based at least on the real target information).

When recognizing the sensor fusion measurement information as real target information and generating the sensor fusion target, the sensor fusion target generation unit 300 may recognize the sensor fusion measurement information as real target information and generate a sensor fusion target in the case in which sensor fusion measurement information whose corresponding the false flag value is not false is continuously determined.

For example, in the case in which sensor fusion measurement information whose corresponding false flag value is not false is continuously determined at least three times, the sensor fusion target generation unit 300 may recognize the sensor fusion measurement information as real target information.

In the present disclosure, as described above, it is possible to determine whether the current sensor fusion measurement information is false based on the parameters learned by the learning unit and to remove false target information, whereby it is possible to effectively prevent the generation of a false sensor fusion target and thus to improve the reliability of the sensor fusion.

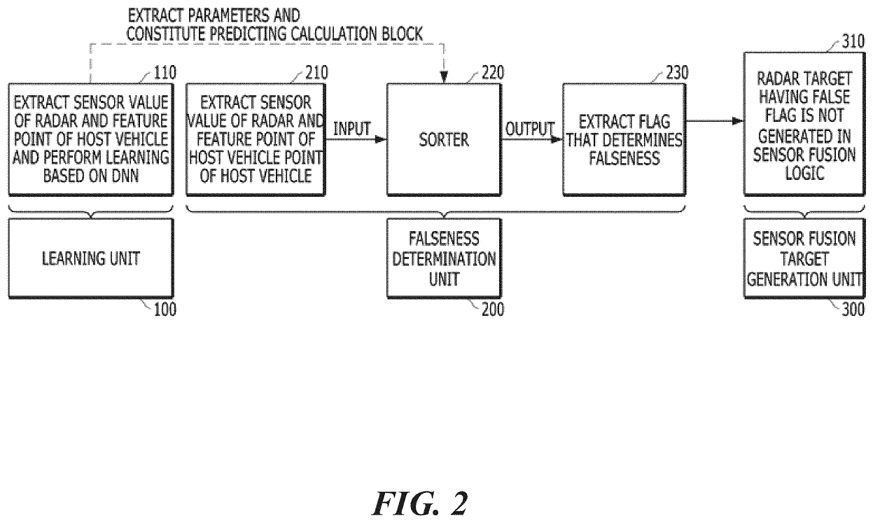

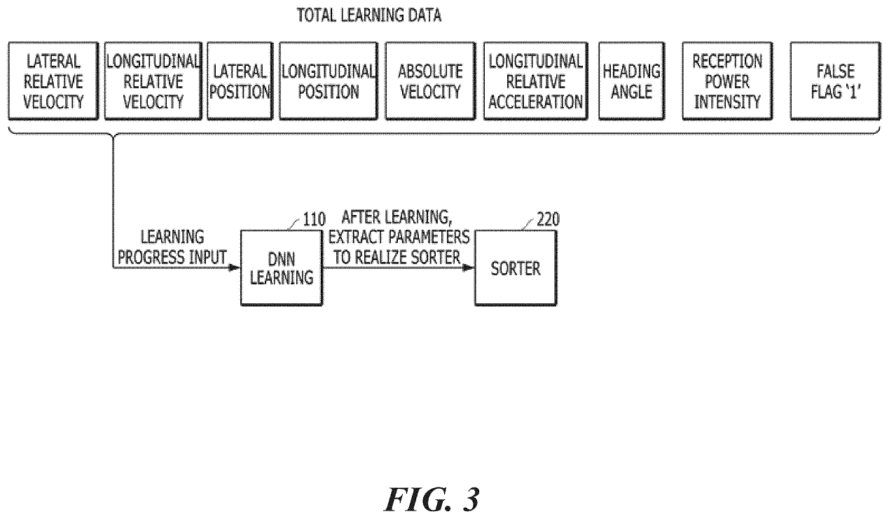

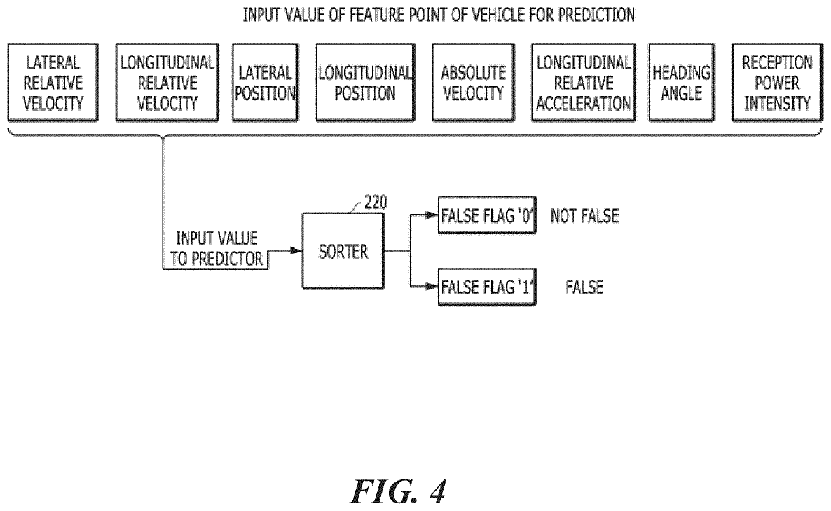

FIG. 2 is a view illustrating a false target removal process in FIG. 1, FIG. 3 is a view illustrating a learning process in FIG. 2, and FIG. 4 is a view illustrating a falseness determination process in FIG. 2.

As shown in FIGS. 2 and 3, the learning unit 100 of the present disclosure may receive and learn sensor fusion measurement information.

For example, the learning unit 100 may extract a sensor value of the radar and a feature point of the host vehicle, and may perform learning based on the deep neural network (DNN) learning method (110).

For example, the learning unit 100 may receive sensor fusion measurement information from the radar of the host vehicle.

When learning the sensor fusion measurement information, the learning unit 100 may learn at least one of lateral relative velocity information, longitudinal relative velocity information, lateral position information, longitudinal position information, absolute velocity information, longitudinal relative acceleration information, heading angle information, reception power intensity information, or false flag information.

Here, the absolute velocity information may be a value calculated based on velocity information of the host vehicle, and the heading angle information may be a value calculated based on the lateral relative velocity information and the longitudinal relative velocity information received from the radar. However, the present disclosure is not limited thereto.

Subsequently, when learning the sensor fusion measurement information, the learning unit 100 may extract a sensor value of the radar and a feature point of the host vehicle from the received sensor fusion measurement information, and may learn the extracted feature point.

When extracting the feature point, the learning unit 100 may extract at least one of lateral relative velocity, longitudinal relative velocity, lateral position, longitudinal position, absolute velocity, longitudinal relative acceleration, heading angle, reception power intensity, or false flag information.

When learning the extracted feature point, the learning unit 100 may learn at least one of the lateral relative velocity, the longitudinal relative velocity, the lateral position, the longitudinal position, the absolute velocity, the longitudinal relative acceleration, the heading angle, or the reception power intensity.

As described above, the learning unit 100 may perform learning based on the deep neural network (DNN) learning method in order to extract learned parameters, and may then constitute a calculation block of a sorter 220.

As shown in FIGS. 2 and 4, upon receiving current sensor fusion measurement information, the falseness determination unit 200 may determine whether the current sensor fusion measurement information is false based on the parameters learned by the learning unit 100.

For example, upon receiving the current sensor fusion measurement information, the falseness determination unit 200 may extract a sensor value of the radar and a feature point of the host vehicle (210).

When extracting the feature point, the falseness determination unit 200 may extract at least one of lateral relative velocity, longitudinal relative velocity, lateral position, longitudinal position, absolute velocity, longitudinal relative acceleration, heading angle, or reception power intensity.

Subsequently, the falseness determination unit 200 may determine whether an input value of the feature point is false based on the learned parameters corresponding to the extracted feature point (220).

When determining whether the input value of the feature point is false, the falseness determination unit 200 may determine whether the input value of the feature point is false based on a predetermined determination reference value. For example, the falseness determination unit 200 may compare the input value of the feature point (or the probability that the input value is false) to a predetermined determination reference value.

For example, the determination reference value may be a falseness probability value of 0.5. However, the present disclosure is not limited thereto, and other falseness probability values may be used.

Subsequently, the falseness determination unit 200 may calculate a false flag value corresponding to the input value of the feature point based on the result of the determination, and may sort (or classify, categorize, or group) the input value of the feature point based on the calculated false flag value (230).

When calculating the false flag value, the falseness determination unit 200 may calculate the false flag value to be 1 upon determining that the input value of the feature point is false, and may calculate the false flag value to be 0 upon determining that the input value of the feature point is not false. However, the present disclosure is not limited thereto, and other false flag values may be used.

The sensor fusion target generation unit 300 may remove false target information and generate a sensor fusion target based on the result of the determination by the falseness determination unit 200.

When generating the sensor fusion target, the sensor fusion target generation unit 300 may check a false flag value corresponding to the sensor fusion measurement information received from the falseness determination unit 200, may recognize the sensor fusion measurement information as false target information based on determining that the false flag value is false, may remove the recognized false target information, and may generate the sensor fusion target (e.g., based on information not including the removed false target information, or without considering the removed false target information).

When checking the false flag value corresponding to the sensor fusion measurement information, the sensor fusion target generation unit 300 may check a false flag value corresponding to the sensor value of the radar and the input value of the feature point of the host vehicle.

For example, when checking the false flag value corresponding to the sensor fusion measurement information, the sensor fusion target generation unit 300 may recognize the sensor fusion measurement information as false target information based on determining that the false flag value is 1, and may recognize the sensor fusion measurement information as real target information based on determining that the false flag value is 0.

When checking the false flag value corresponding to the sensor fusion measurement information received from the falseness determination unit 200, the sensor fusion target generation unit 300 may recognize the sensor fusion measurement information as real target information based on determining that the false flag value is not false, and may generate a sensor fusion target (e.g., based at least on the real target information).

When recognizing the sensor fusion measurement information as real target information and generating the sensor fusion target, the sensor fusion target generation unit 300 may recognize the sensor fusion measurement information as real target information and generate a sensor fusion target in the case in which sensor fusion measurement information whose corresponding false flag value is not false is continuously determined.

For example, in the case in which sensor fusion measurement information whose corresponding false flag value is not false is continuously determined at least three times, the sensor fusion target generation unit 300 may recognize the sensor fusion measurement information as real target information.

As described above, the sensor fusion target generation unit 300 may extract parameters sorted by the sorter, and may provide the extracted parameters to sensor fusion logic in real time.

The sensor fusion target generation unit 300 may add a portion using the extracted parameters to a preprocessing portion of the sensor fusion logic in order to determine whether a radar target measured in real time is a false target.

Subsequently, the sensor fusion target generation unit 300 may exclude the result of preprocessing in a target generation portion in which the false flag of the radar target is 1 from the generation of the sensor fusion target.

Here, the sensor fusion target generation unit 300 may determine the continuous validity of a target when generating the target. In the case in which continuity is not realized due to a false flag corresponding to a portion that is generated as a real target, no target may be generated.

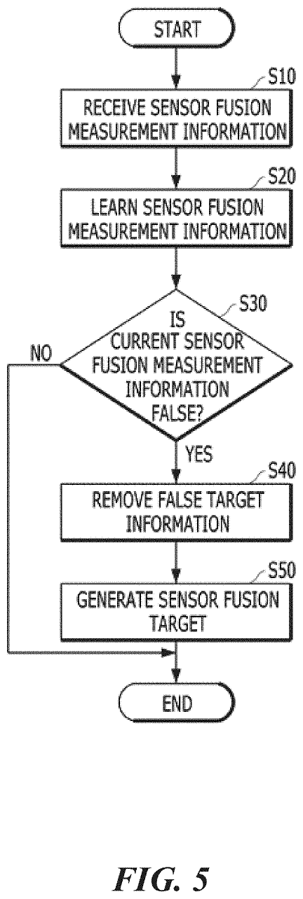

FIG. 5 is a flowchart illustrating a false target removal method according to an embodiment of the present disclosure.

As shown in FIG. 5, sensor fusion measurement information may be received (S10).

Here, the sensor fusion measurement information may be received from the radar of the host vehicle.

Subsequently, the received sensor fusion measurement information may be learned (S20).

Here, at least one of lateral relative velocity information, longitudinal relative velocity information, lateral position information, longitudinal position information, absolute velocity information, longitudinal relative acceleration information, heading angle information, or reception power intensity information may be learned.

Depending on the circumstances, false flag information may be further learned.

Here, the absolute velocity information may be a value calculated based on velocity information of the host vehicle. However, the present disclosure is not limited thereto.

The heading angle information may be a value calculated based on the lateral relative velocity information and the longitudinal relative velocity information received from the radar. However, the present disclosure is not limited thereto.

In addition, for example, when the sensor fusion measurement information is learned, learning may be performed based on the deep neural network (DNN) learning method.

The step of learning the sensor fusion measurement information may include extracting a sensor value of the radar and a feature point of the host vehicle from the received sensor fusion measurement information and learning the extracted feature point.

At the step of extracting the feature point, at least one of lateral relative velocity, longitudinal relative velocity, lateral position, longitudinal position, absolute velocity, longitudinal relative acceleration, heading angle, or reception power intensity may be extracted.

At the step of learning the extracted feature point, at least one of the lateral relative velocity, the longitudinal relative velocity, the lateral position, the longitudinal position, the absolute velocity, the longitudinal relative acceleration, the heading angle, or the reception power intensity may be learned.

At the step of learning the extracted feature point, false flag information may be further learned.

For example, at the step of learning the extracted feature point, learning may be performed based on the deep neural network (DNN) learning method.

Subsequently, whether the current sensor fusion measurement information is false may be determined based on the learned parameters (S30).

When determining whether the current sensor fusion measurement information is false, the false target removal method according to the present disclosure may include extracting a sensor value of the radar and a feature point of the host vehicle upon receiving the current sensor fusion measurement information, determining whether an input value of the feature point is false based on the learned parameters corresponding to the extracted feature point, calculating a false flag value corresponding to the input value of the feature point based on the result of the determination, and sorting (or classifying, categorizing, or grouping) the input value of the feature point based on the calculated false flag value.

At the step of extracting the feature point, at least one of lateral relative velocity, longitudinal relative velocity, lateral position, longitudinal position, absolute velocity, longitudinal relative acceleration, heading angle, or reception power intensity may be extracted.

At the step of determining whether the input value of the feature point is false, whether the input value of the feature point is false may be determined based on a predetermined determination reference value. For example, the falseness determination unit 200 may compare the input value of the feature point (or the probability that the input value is false) to a predetermined determination reference value.

For example, the determination reference value may be a falseness probability value of 0.5. However, the present disclosure is not limited thereto, and other falseness probability values may be used.

At the step of calculating the false flag value, the false flag value may be calculated to be 1 upon determining that the input value of the feature point is false, and the false flag value may be calculated to be 0 upon determining that the input value of the feature point is not false.

Upon determining that the current sensor fusion measurement information is false, false target information may be removed (S40), and a sensor fusion target may be generated (S50).

When generating the sensor fusion target, the false target removal method according to the present disclosure may include checking a false flag value corresponding to the received sensor fusion measurement information, recognizing the sensor fusion measurement information as false target information based on determining that the false flag value is false, removing the recognized false target information, and generating the sensor fusion target (e.g., based on information not including the removed false target information, or without considering the removed false target information).

At the step of checking the false flag value corresponding to the sensor fusion measurement information, a false flag value corresponding to the sensor value of the radar and the input value of the feature point of the host vehicle may be checked.

In addition, at the step of checking the false flag value corresponding to the sensor fusion measurement information, the sensor fusion measurement information may be recognized as false target information based on determining that the false flag value is 1, and the sensor fusion measurement information may be recognized as real target information based on determining that the false flag value is 0.

In addition, at the step of checking the false flag value corresponding to the sensor fusion measurement information, the sensor fusion measurement information may be recognized as real target information based on determining that the false flag value is not false, and a sensor fusion target may be generated (e.g., based at least on the real target information).

At the step of recognizing the sensor fusion measurement information as real target information and generating the sensor fusion target, the sensor fusion measurement information may be recognized as real target information and a sensor fusion target may be generated in the case in which sensor fusion measurement information whose corresponding false flag value is not false is continuously determined.

For example, at the step of recognizing the sensor fusion measurement information as real target information and generating the sensor fusion target, the sensor fusion measurement information may be recognized as real target information in the case in which sensor fusion measurement information whose corresponding false flag value is not false is continuously determined at least three times.

In addition, a computer-readable recording medium containing a program for performing the false target removal method according to the present disclosure may execute the processes included in the false target removal method.

Meanwhile, a vehicle according to an embodiment of the present disclosure may include a sensor fusion device for sensing a target and a false target removal device connected to the sensor fusion device through communication for removing false target information corresponding to the target, wherein the false target removal device may include a learning unit for receiving and learning sensor fusion measurement information, a falseness determination unit for, upon receiving current sensor fusion measurement information, determining whether the current sensor fusion measurement information is false based on parameters learned by the learning unit, and a sensor fusion target generation unit for removing false target information and generating a sensor fusion target based on the result of the determination by the falseness determination unit.

In the present disclosure, as described above, it is possible to determine whether the current sensor fusion measurement information is false based on the parameters learned by the learning unit and to remove false target information, whereby it is possible to efficiently prevent the generation of a false sensor fusion target and thus to improve the reliability of the sensor fusion.

For example, in the present disclosure, it may be difficult to analyze the error of a value measured by the sensor. Consequently, whether the final sensor fusion target is a false target may be determined using DNN, and the logic of a target generation portion in the sensor fusion may be executed using the DNN result value in order to prevent the generation of the false target in the sensor fusion logic.

The false target removal method according to the present disclosure described above may be implemented as a computer-readable program stored in a computer-readable recording medium. The computer-readable medium may be any type of recording device in which data is stored in a computer-readable manner. The computer-readable medium may include, for example, a hard disk drive (HDD), a solid-state disk (SSD), a silicon disk drive (SDD), a read-only memory (ROM), a random access memory (RAM), a compact disc read-only memory (CD-ROM), a magnetic tape, a floppy disk, and an optical data storage device, as well as implementation as carrier waves (e.g., transmission over the Internet).

As is apparent from the above description, the false target removal device and method for vehicles and the vehicle including the device according to at least one embodiment of the present disclosure are capable of determining whether the current sensor fusion measurement information is false based on the parameters learned by the learning unit and removing false target information, whereby it is possible to efficiently prevent the generation of a false sensor fusion target and thus to improve the reliability of the sensor fusion.

It will be appreciated by those skilled in the art that the effects achievable through the present disclosure are not limited to those that have been particularly described hereinabove and that other effects of the present disclosure will be more clearly understood from the above detailed description.

The above detailed description is not to be construed as limiting the present disclosure in any aspect, but is to be considered by way of example. The scope of the present disclosure should be determined by reasonable interpretation of the accompanying claims, and all equivalent modifications made without departing from the scope of the present disclosure should be understood to be included in the following claims.

What is claimed is:

1. A false target removal device for vehicles, the false target removal device comprising:
a learning unit configured to receive sensor fusion measurement information and learn one or more parameters based on the received sensor fusion measurement information;
a falseness determination unit configured to, upon receiving current sensor fusion measurement information, determine whether the current sensor fusion measurement information is false based on the one or more parameters learned by the learning unit; and
a sensor fusion target generation unit configured to remove false target information and to generate a sensor fusion target based on a result of the determination by the falseness determination unit.

2. The false target removal device according to claim 1, wherein the learning unit is further configured to learn at least one of lateral relative velocity information, longitudinal relative velocity information, lateral position information, longitudinal position information, absolute velocity information, longitudinal relative acceleration information, heading angle information, or reception power intensity information.

3. The false target removal device according to claim 1, wherein the learning unit is further configured to extract a sensor value of a radar and a feature point of a host vehicle from the received sensor fusion measurement information and learn the extracted feature point.

4. The false target removal device according to claim 1, wherein the falseness determination unit is further configured to extract a sensor value of a radar and a feature point of a host vehicle upon receiving the current sensor fusion measurement information, determine whether an input value of the feature point is false based on learned parameters corresponding to the extracted feature point, calculate a false flag value corresponding to the input value of the feature point based on a result of determination, and categorize the input value of the feature point based on the calculated false flag value.

5. The false target removal device according to claim 4, wherein the falseness determination unit is further configured to extract at least one of lateral relative velocity, longitudinal relative velocity, lateral position, longitudinal position, absolute velocity, longitudinal relative acceleration, heading angle, or reception power intensity.

6. The false target removal device according to claim 4, wherein the falseness determination unit is further configured to calculate the false flag value to be 1 upon determining that the input value of the feature point is false, and calculate the false flag value to be 0 upon determining that the input value of the feature point is not false.

7. The false target removal device according to claim 1, wherein the sensor fusion target generation unit is configured to determine a false flag value corresponding to the sensor fusion measurement information received from the falseness determination unit, recognize the sensor fusion measurement information as false target information based on the false flag value being false, remove the recognized false target information, and generate the sensor fusion target.

8. The false target removal device according to claim 7, wherein the sensor fusion target generation unit is further configured to determine a false flag value corresponding to a sensor value of a radar and an input value of a feature point of a host vehicle.

9. The false target removal device according to claim 7, wherein the sensor fusion target generation unit is further configured to recognize the sensor fusion measurement information as false target information based on the false flag value being 1, and recognize the sensor fusion measurement information as real target information based on the false flag value being 0.

10. The false target removal device according to claim 7, wherein the sensor fusion target generation unit is further configured to recognize the sensor fusion measurement information as real target information based on the false flag value not being false, and generate the sensor fusion target.

11. A false target removal method for vehicles, the false target removal method comprising:
receiving sensor fusion measurement information;
learning one or more parameters based on the received sensor fusion measurement information;
determining whether current sensor fusion measurement information is false based on the one or more learned parameters; and
removing false target information and generating a sensor fusion target upon determining that the current sensor fusion measurement information is false.

12. The false target removal method according to claim 11, wherein the step of learning the sensor fusion measurement information comprises learning at least one of lateral relative velocity information, longitudinal relative velocity information, lateral position information, longitudinal position information, absolute velocity information, longitudinal relative acceleration information, heading angle information, or reception power intensity information.

13. The false target removal method according to claim 11, wherein the step of learning the sensor fusion measurement information comprises:
extracting a sensor value of a radar and a feature point of a host vehicle from the received sensor fusion measurement information; and
learning the extracted feature point.

14. The false target removal method according to claim 11, wherein the step of determining whether the current sensor fusion measurement information is false comprises:
extracting a sensor value of a radar and a feature point of a host vehicle upon receiving the current sensor fusion measurement information;
determining whether an input value of the feature point is false based on learned parameters corresponding to the extracted feature point;
calculating a false flag value corresponding to the input value of the feature point based on a result of determination; and
categorizing the input value of the feature point based on the calculated false flag value.

15. The false target removal method according to claim 14, wherein the step of extracting the feature point comprises extracting at least one of lateral relative velocity, longitudinal relative velocity, lateral position, longitudinal position, absolute velocity, longitudinal relative acceleration, heading angle, or reception power intensity.

16. The false target removal method according to claim 14, wherein the step of calculating the false flag value comprises one of (i) calculating the false flag value to be 1 upon determining that the input value of the feature point is false, or (ii) calculating the false flag value to be 0 upon determining that the input value of the feature point is not false.

17. The false target removal method according to claim 11, wherein the step of generating the sensor fusion target comprises:
determining a false flag value corresponding to the received sensor fusion measurement information;
recognizing the sensor fusion measurement information as false target information based on the false flag value being false; and
removing the recognized false target information and generating the sensor fusion target.

18. The false target removal method according to claim 17, wherein the step of determining the false flag value corresponding to the sensor fusion measurement information comprises determining a false flag value corresponding to a sensor value of a radar and an input value of a feature point of a host vehicle.

19. The false target removal method according to claim 17, wherein the step of determining the false flag value corresponding to the sensor fusion measurement information comprises one of (i) recognizing the sensor fusion measurement information as false target information based on the false flag value being 1, or (ii) recognizing the sensor fusion measurement information as real target information based on the false flag value being 0.

20. The false target removal method according to claim 17, wherein the step of determining the false flag value corresponding to the sensor fusion measurement information comprises recognizing the sensor fusion measurement information as real target information based on the false flag value not being false and generating the sensor fusion target.
